(19) United States
(12) Patent Application Publication
(10) Pub. No.: US 2012/0008008 A1
(43) Pub. Date: Jan. 12, 2012

(54) IMAGE PROCESSING DEVICE, IMAGING METHOD, IMAGING PROGRAM, IMAGE PROCESSING METHOD, AND IMAGE PROCESSING PROGRAM

(75) Inventors: Kiyotaka NAKABAYASHI, Saitama (JP); Junya SUZUKI, Tokyo (JP)

(73) Assignee: Sony Corporation, Tokyo (JP)

(21) Appl. No.: 13/159,685

(22) Filed: Jun. 14, 2011

(30) Foreign Application Priority Data
Jul. 6, 2010 (JP) 2010-154262

(51) Int. Cl. H04N 9/73; G06K 9/46; H04N 5/225

(52) U.S. Cl. 348/223.1; 348/222.1; 382/190; 348/E05.024; 348/E09.052

(57) ABSTRACT

An image processing device includes: an image generating unit that generates third image data on the basis of first image data and second image data different in exposure condition from the first image data; a subject recognizer that recognizes a predetermined subject on the basis of the first image data; and a brightness value condition detector that detects a brightness value condition of an area around the predetermined subject recognized by the subject recognizer in the first image data, wherein the image generating unit generates the third image data on the basis of the detection result in the brightness value condition detector.

### FIELD

The present disclosure relates to an image processing device, an imaging method, an imaging program, an image processing method, and an image processing program.

More particularly, the present disclosure relates to an image processing device, an imaging method, an imaging program, an image processing method, and an image processing program, which can perform a precise white balance adjusting process on the motion of a subject.

### BACKGROUND

As is well known, digital cameras have become widespread. A demand in the market for imaging capability of a digital camera has become very high. In the market, there is a need for a digital camera capable of taking a clear and beautiful image.

Approaches in a digital camera for taking a clear and beautiful image are roughly classified into two. One approach is the technological innovation of an imaging device. Another approach is a technique of processing taken image data.

In general, when a subject is shot using a flash in a dark place with a digital camera, it is known that a phenomenon in which the color balance is broken between a place (corresponding to the subject) illuminated brightly by the flash and a place (corresponding to a space around the subject) not illuminated by the flash often occurs. This problem is caused because the white balance of the flash is different from the white balance of a light source illuminating the surroundings.

In a camera according to the related art using a silver halide film, there was no fundamental solution to the problem with the white balance. However, in the digital camera, the white balance can be freely adjusted locally by appropriately processing image data acquired from an imaging device. Accordingly, by developing the technique of appropriately processing the acquired image data, it is possible to obtain a natural, clear, and beautiful image under a poor imaging condition which is not able to be coped with by the silver halide camera.

JP-A-2005-210485 discloses a technique of automatically performing an appropriate white balance adjustment between a place illuminated brightly by the flash and a place not illuminated by the flash by performing an appropriate calculation process using the phenomenon in which the color balance is broken between the place illuminated brightly by the flash and the place not illuminated by the flash by the use of a non-luminous image captured not using the flash and a luminous image captured using the flash.

### SUMMARY

In the technique disclosed in JP-A-2005-210485, as for an actual digital camera, image data at the time of pressing a shutter button is used as the luminous image and monitoring image data just before pressing the shutter button is used as the non-luminous image. In order to cause a difference between the non-luminous image and the luminous image to be as little as possible, the newest image data just before the imaging among the monitoring image data stored in a frame buffer and normally updated is used as the non-luminous image.

However, in the technique disclosed in JP-A-2005-210485, the appropriate white balance process may not be performed depending on the subject or the imaging environment but color unevenness (color shift) may be caused locally.

In one case, the subject is moving. In this case, since the subject is moving between the luminous image and the non-luminous image, the color shift is caused in the place in which the subject is moving.

FIGS. 16A, 16B, and 16C are diagrams schematically illustrating the phenomenon of color shift occurring due to the motion of a subject. When the technique disclosed in JP-A-2005-210485 is used and when a subject is moving between a non-luminous image and a luminous image, the white balance in the corresponding place is broken and color shift occurs as a result.

In another case, the background of a subject is illuminated partially brightly. In this case, since local unevenness in white balance occurs in a non-luminous image, color shift is caused in the place in which the background of the subject is partially bright.

Thus, it is desirable to provide an image processing device, an imaging method, an imaging program, an image processing method, and an image processing program, which can perform an appropriate white balance adjusting process on all subjects under all the imaging conditions only by adding a small number of calculation processes and which can acquire excellent still image data from almost all the subjects.

An image processing device according to an embodiment of the present disclosure includes: a data processor that receives a predetermined imaging instruction, that processes data based on a signal output from an imaging device, and that outputs captured image data; a monitoring processor that processes the data based on the signal output from the imaging device for monitoring and that outputs monitoring image data; a white balance creating unit that calculates a white balance value uniform over all of the captured image data on the basis of the captured image data; a white balance map creating unit that calculates a white balance map varying for every pixel of the captured image data on the basis of the captured image data and the monitoring image data; a mixing coefficient calculator that calculates a coefficient used to mix the white balance map with the white balance value on the basis of the captured image data and the monitoring image data; an adder that adds the white balance value and the white balance map using the mixing coefficient and that outputs a corrected white balance map; and a multiplier that multiplies the captured image data by the corrected white balance map.

According to this configuration, the mixing coefficient calculator is disposed which changes a mixture ratio on the basis of the motion of the subject and the brightness of the background of the subject at the time of creating the corrected white balance map by mixing the white balance value used to set uniform white balance over all of the captured image data with the white balance map used to set the optimal white balance based on the brightness of the pixels of the captured image data. Accordingly, by changing the mixing coefficient, it is possible to prevent the color shift and to perform an appropriate white balance correcting process on the basis of the motion of a subject and the brightness of the background of the subject.

According to the embodiment of the present disclosure, it is possible to provide an image processing device, an imaging method, an imaging program, an image processing method, and an image processing program, which can perform an appropriate white balance adjusting process on all the subjects under all the imaging conditions only by adding a small number of calculation processes and which can acquire excellent still image data from almost all the subjects.

### BRIEF DESCRIPTION OF THE DRAWINGS

FIG. 1A is a diagram illustrating the front appearance of a digital camera and FIG. 1B is a diagram illustrating the rear appearance of the digital camera.

FIG. 2 is a hardware block diagram illustrating the configuration of the digital camera.

FIG. 3 is a functional block diagram illustrating the configuration of the digital camera.

FIG. 4 is a functional block diagram illustrating the configuration of a white balance processor.

FIG. 5 is a functional block diagram illustrating the configuration of a white balance map creating unit.

FIG. 6 is a functional block diagram illustrating the configuration of a mixing coefficient calculating unit.

FIG. 7A is a diagram schematically illustrating the relation between monitoring image data stored in a motion-detecting frame buffer and a face frame, FIG. 7B is a diagram schematically illustrating the relation between the monitoring image data stored in a monitoring image frame buffer and the face frame, and FIG. 7C is a diagram schematically illustrating the relation between the captured image data, the face frame, and the high-brightness frame.

FIG. 8 is a functional block diagram illustrating the configuration of a high-brightness checker.

FIGS. 9A and 9B are graphs illustrating the input and output relation of a correction value converter.

FIG. 10 is a flow diagram illustrating a flow of processes of calculating mixing coefficients “k” and “1−k”, which are performed by a mixing coefficient calculator.

FIGS. 11A to 11F are diagrams schematically illustrating the relation between a subject, a subject identification frame, and a high-brightness frame.

FIG. 12 is a functional block diagram illustrating the configuration of a digital camera.

FIG. 13 is a functional block diagram illustrating the configuration of an image processing device.

FIG. 14 is a functional block diagram in which a part of the mixing coefficient calculator is modified.

FIG. 15 is a graph illustrating the input and output relation of the correction value converter.

FIGS. 16A to 16C are diagrams schematically illustrating a phenomenon of color shift which is caused because a subject is moving.

### DETAILED DESCRIPTION

### [Appearance]

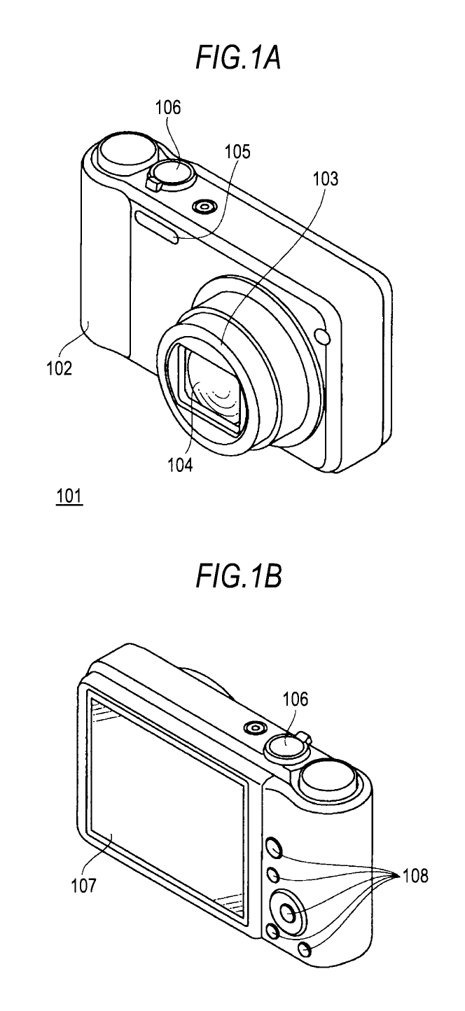

FIG. 1A is a diagram illustrating the front appearance of a digital camera and FIG. 1B is a diagram illustrating the rear appearance of the digital camera.

In a digital camera 101, a barrel 103 including a zoom mechanism and a focus adjusting mechanism not shown therein is disposed on the front surface of a casing 102 and a lens 104 can be assembled inside the barrel 103. A flash 105 is disposed on one side of the barrel 103.

A shutter button 106 is disposed on the top surface of the casing 102.

A liquid crystal display monitor 107 also used as a view finder is disposed on the rear surface of the casing 102. Plural operation buttons 108 are disposed on the right side of the liquid crystal display monitor 107.

A cover for housing a flash memory serving as a nonvolatile storage is disposed on the bottom surface of the casing 102, which is not shown.

The digital camera 101 according to this embodiment is a so-called digital still camera, which takes an image of a subject, creates still image data, and records the created still image data in the nonvolatile storage. The digital camera 101 also has a moving image capturing function, which is not described in this embodiment.

### [Hardware]

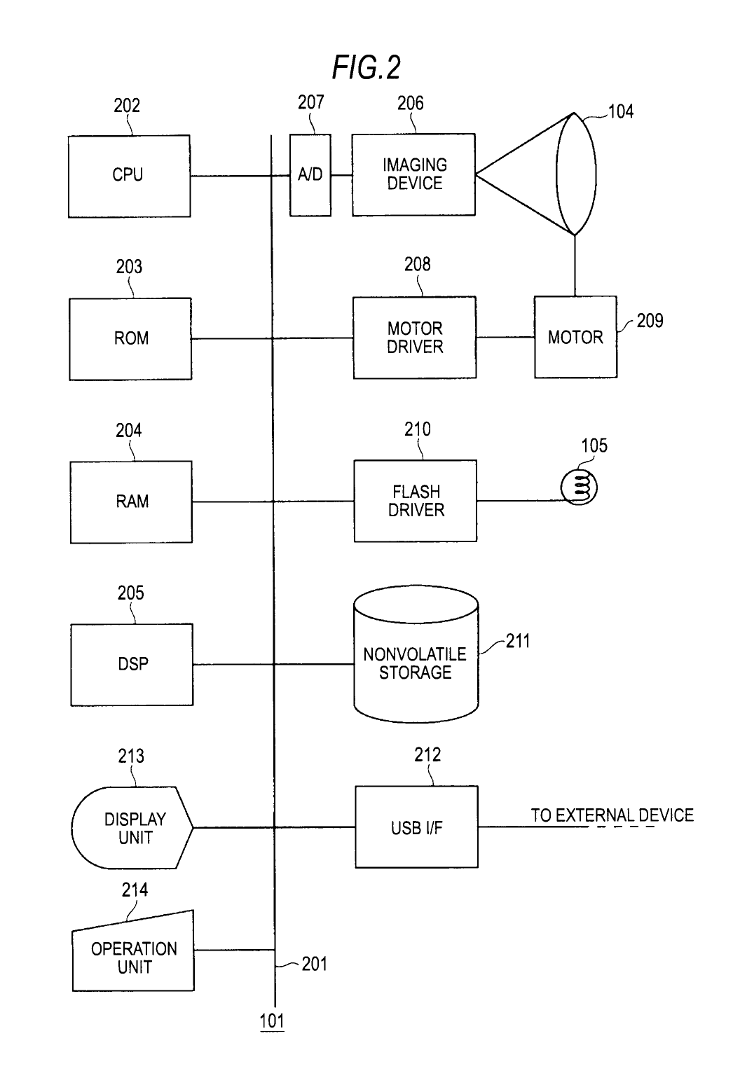

FIG. 2 is a hardware block diagram illustrating the configuration of the digital camera 101.

The digital camera 101 includes a typical micro computer.

A CPU 202, a ROM 203, and a RAM 204 which are necessary for the overall control of the digital camera 101 are connected to a bus 201 and a DSP 205 is also connected to the bus 201. The DSP 205 performs a large number of calculation processes on a large amount of data of digital image data which is necessary for realizing a white balance adjusting process to be described in this embodiment.

An imaging device 206 converts light emitted from a subject and imaged by the lens 104 into an electrical signal. The analog signal output from the imaging device 206 is converted into a digital signal of R, G, and B by an A/D converter 207.

A motor 209 driven by a motor driver 208 drives the lens 104 via the barrel 103 and performs the focusing and zooming control.

The flash 105 is driven to emit light by a flash driver 210.

The captured digital image data is recorded as a file in a nonvolatile storage 211.

A USB interface 212 is disposed to transmit and receive a file, which is stored in the nonvolatile storage 211, to and from an external device such as a PC.

A display unit 213 is the liquid crystal display monitor 107.

An operation unit 214 includes the shutter button 106 and the operation buttons 108.

### [Software Configuration]

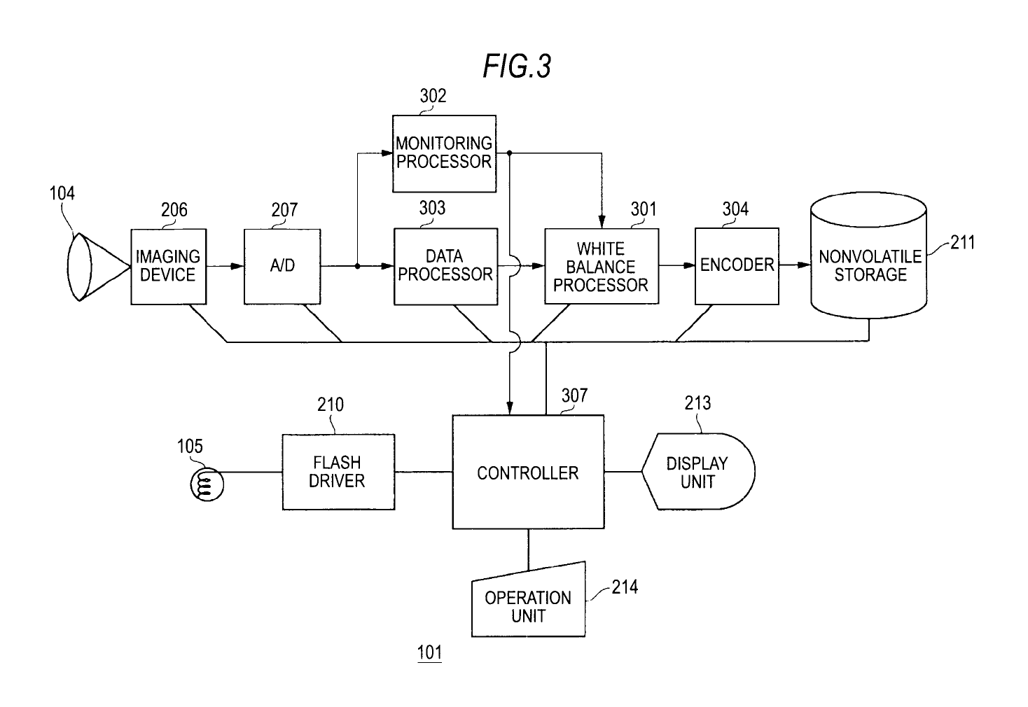

FIG. 3 is a functional block diagram illustrating the configuration of the digital camera 101.

The light emitted from the subject is imaged on the imaging device 206 by the lens 104 and is converted into an electrical signal.

The converted signal is converted into a digital signal of R, G, and B by the A/D converter 207.

Under the control of a controller 307 responding to the operation of the shutter button 106 which is a part of the operation unit 214, a data processor 303 receives data from the A/D converter 207, performs various processes such as sorting, defect correction, and size change of data, and outputs the resultant to a white balance processor 301 which is also referred to as an image generating unit.

The lens 104, the imaging device 206, the A/D converter 207, and the data processor 303 can be also referred to as an imaging processor that forms digital image data (hereinafter, referred to as “captured image data”) at the time of imaging a subject and that outputs the captured image data to the white balance processor 301.

On the other hand, the data output from the A/D converter 207 is output to a monitoring processor 302. The monitoring processor 302 performs a size changing process suitable for displaying the data on the display unit 213, forms monitoring image data, and outputs the monitoring image data to the white balance processor 301 and the controller 307.

The white balance processor 301 receives the captured image data output from the data processor 303 and the monitoring image data output from the monitoring processor 302 and performs a white balance adjusting process on the captured image data.

The captured image data having been subjected to the white balance adjusting process by the white balance processor 301 is converted into a predetermined image data format such as JPEG by an encoder 304 and is then stored as an image file in the nonvolatile storage 211 such as a flash memory.

The controller 307 controls the imaging device 206, the A/D converter 207, the data processor 303, the white balance processor 301, the encoder 304, and the nonvolatile storage 211 in response to the operation of the operation unit 214 or the like. Particularly, when the operation of the shutter button 106 in the operation unit 214 is detected, a trigger signal is output to the imaging device 206, the A/D converter 207, and the data processor 303 to generate captured image data.

The controller 307 receives the monitoring image data from the monitoring processor 302, displays the image formed on the imaging device 206 on the display unit 213, and displays various setting pictures on the basis of the operation of the operation unit 214.

### [White Balance Processor]

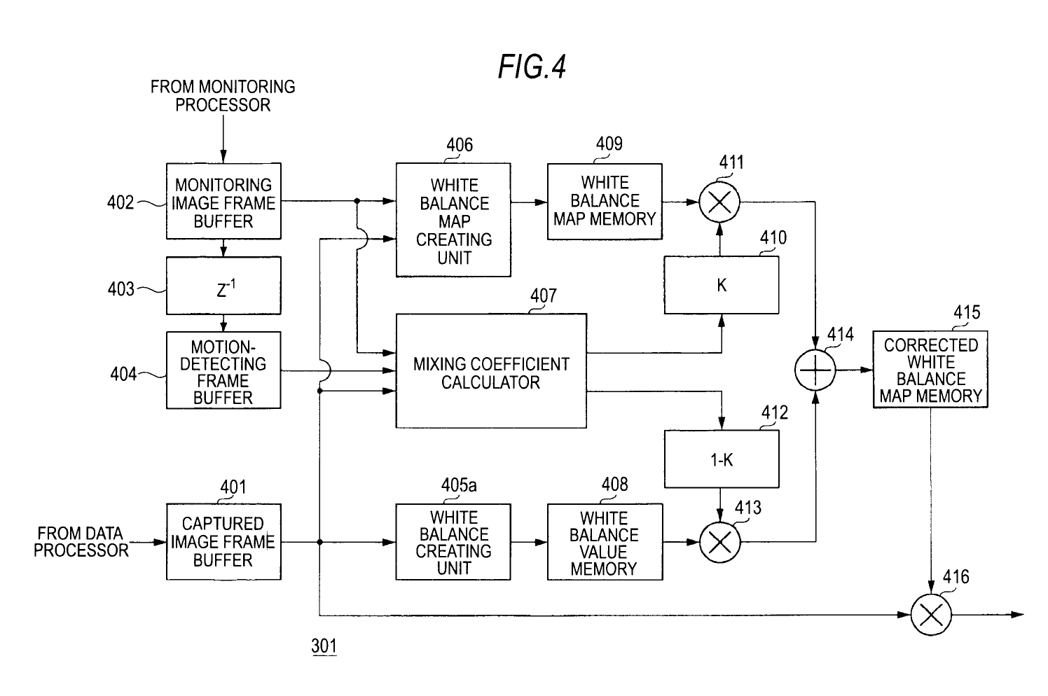

FIG. 4 is a functional block diagram illustrating the configuration of the white balance processor 301.

The captured image data output from the data processor 303 is temporarily stored in a captured image frame buffer 401.

The monitoring image data output from the monitoring processor 302 is temporarily stored in a monitoring image frame buffer 402.

The monitoring image data output from the monitoring image frame buffer 402 is stored in a motion-detecting frame buffer 404 via a delay element 403. That is, the monitoring image data stored in the monitoring image frame buffer 402 and the monitoring image data stored in the motion-detecting frame buffer 404 have a time difference corresponding to a frame.

The monitoring image frame buffer 402 continues to be updated with the newest monitoring image data. However, the update of the monitoring image frame buffer 402 is temporarily stopped under the control of the controller 307 at the time of storing the captured image data in the captured image frame buffer 401, and the update of the monitoring image frame buffer 402 is stopped until the overall processes in the white balance processor 301 are finished.

Similarly, the motion-detecting frame buffer 404 continues to be updated with the monitor image data delayed by a frame relative to the monitoring image frame buffer 402. However, the update of the motion-detecting frame buffer 404 is temporarily stopped under the control of the controller 307 at the time of storing the captured image data in the captured image frame buffer 401, and the update of the motion-detecting frame buffer 404 is stopped until the overall processes in the white balance processor 301 are finished.

The captured image data stored in the captured image frame buffer 401 is supplied to a white balance creating unit 405a, a white balance map creating unit 406, and a mixing coefficient calculator 407.

The white balance creating unit 405a reads the captured image data and performs a known process of calculating a white balance value. Specifically, an average brightness value of the captured image data is calculated and the captured image data is divided into an area of pixels illuminated brightly by the flash and an area of pixels not illuminated by the flash using the average brightness value as a threshold. White balance values uniform over all of the captured image data are calculated with reference to color temperature information of the flash stored in advance in the ROM 203 regarding the bright area of pixels and information of the imaging conditions acquired from the controller 307. The white balance values are three multiplication values to be evenly multiplied by red (R), green (G), and blue (B) data of the pixels.

The white balance values are temporarily stored in a white balance value memory 408 formed in the RAM 204.

The monitoring image data stored in the monitoring image frame buffer 402 in addition to the captured image data stored in the captured image frame buffer 401 is input to the white balance map creating unit 406.

The white balance map creating unit 406 reads the captured image data and the monitoring image data and performs a white balance map calculating process. The white balance map is data used to perform the appropriate white balance adjustment on the area of pixels illuminated brightly by the flash and the area of pixels not illuminated by the flash among the captured image data. That is, the value corresponding to the bright area of pixels and the value corresponding to the dark area of pixels are different from each other. Accordingly, the white balance map is a set of values to be added to or subtracted from the red (R), green (G), and blue (B) data of the pixels for each pixel and the number of elements thereof is the same as the number of elements of the captured image data.

The white balance map is temporarily stored in a white balance map memory 409 formed in the RAM 204.

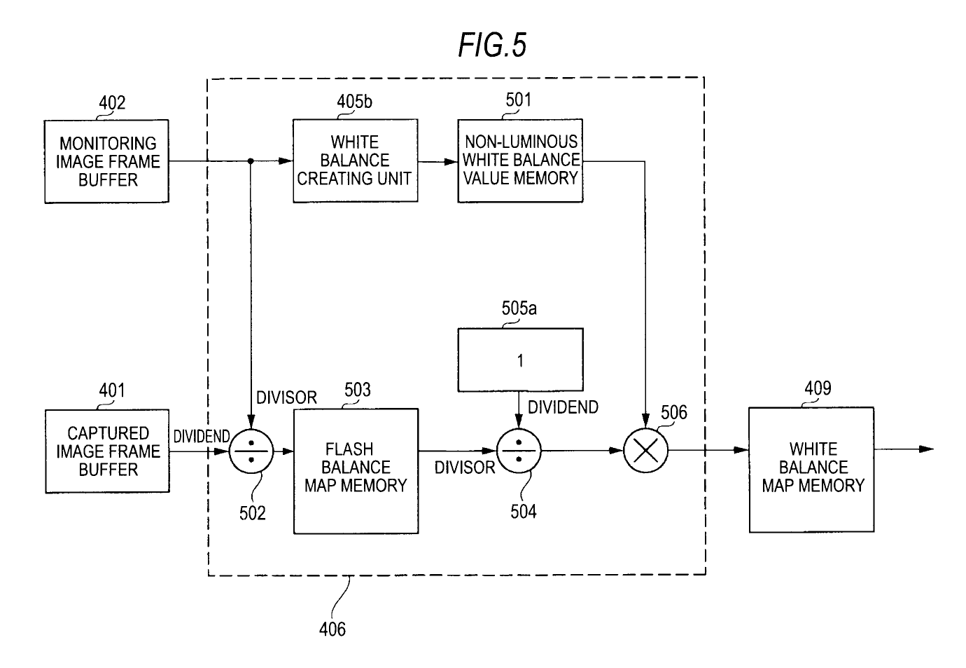

The details of the white balance map creating unit 406 will be described later with reference to FIG. 5.

The monitoring image data stored in the monitoring image frame buffer 402 and the monitoring image data stored in the motion-detecting frame buffer 404 in addition to the captured image data stored in the captured image frame buffer 401 are input to the mixing coefficient calculator 407.

The mixing coefficient calculator 407 reads the captured image data and the monitoring image data corresponding to two frames and performs a process of calculating a mixing coefficient “k” and a mixing coefficient “1−k”.

The mixing coefficient “k” is stored in a mixing coefficient “k” memory 410 formed in the RAM 204. The mixing coefficient “k” stored in the mixing coefficient “k” memory 410 is multiplied by the white balance map stored in the white balance map memory 409 by a multiplier 411.

On the other hand, the mixing coefficient “1−k” is stored in a mixing coefficient “1−k” memory 412 formed in the RAM 204. The mixing coefficient “1−k” stored in the mixing coefficient “1−k” memory 412 is multiplied by the white balance value stored in the white balance value memory 408 by a multiplier 413.

A corrected white balance map output from the multiplier 411 and a corrected white balance map output from the multiplier 413 are added by an adder 414. Specifically, red data of the corrected white balance value is added to red data of each pixel which constitutes the corrected white balance map, green data of the corrected white balance value is added to green data of each pixel which constitutes the corrected white balance map, and blue data of the corrected white balance value is added to blue data of each pixel which constitutes the corrected white balance map. In this way, the adder 414 outputs the corrected white balance map. The corrected white balance map is temporarily stored in a white balance map memory 415.

The corrected white balance map stored in the corrected white balance map memory 415 is multiplied by the captured image data by a multiplier 416. In this way, the white balance of the captured image data is adjusted.

### [White Balance Map Creating Unit]

FIG. 5 is a functional block diagram illustrating the configuration of the white balance map creating unit 406.

The monitoring image data stored in the monitoring image frame buffer 402 is input to a white balance creating unit 405b. The white balance creating unit 405b performs the same process as in the white balance creating unit 405a shown in FIG. 4. The white balance creating unit 405b outputs a non-luminous white balance value. The non-luminous white balance value is temporarily stored in a non-luminous white balance value memory 501.

On the other hand, a divider 502 divides the captured image data stored in the captured image frame buffer 401 by the monitoring image data stored in the monitoring image frame buffer 402. At the time of division, when the number of pixels in the captured image data is different from the number of pixels in the monitoring image data, the monitoring image data is appropriately subjected to an enlarging or reducing process to match the number of pixels (the number of elements to be calculated) with each other.

The divider 502 outputs a flash balance map as the result of division. The flash balance map is temporarily stored in a flash balance map memory 503.

A divider 504 divides a numerical value “1” 505a by the respective elements of the flash balance map stored in the flash balance map memory 503. That is, the output data of the divider 504 is the reciprocal of the flash balance map.

A multiplier 506 multiplies the output data of the divider 504 by the non-luminous white balance value stored in the non-luminous white balance value memory 501 and outputs the white balance map. This white balance map is stored in the white balance map memory 409.

### [Mixing Coefficient Calculator]

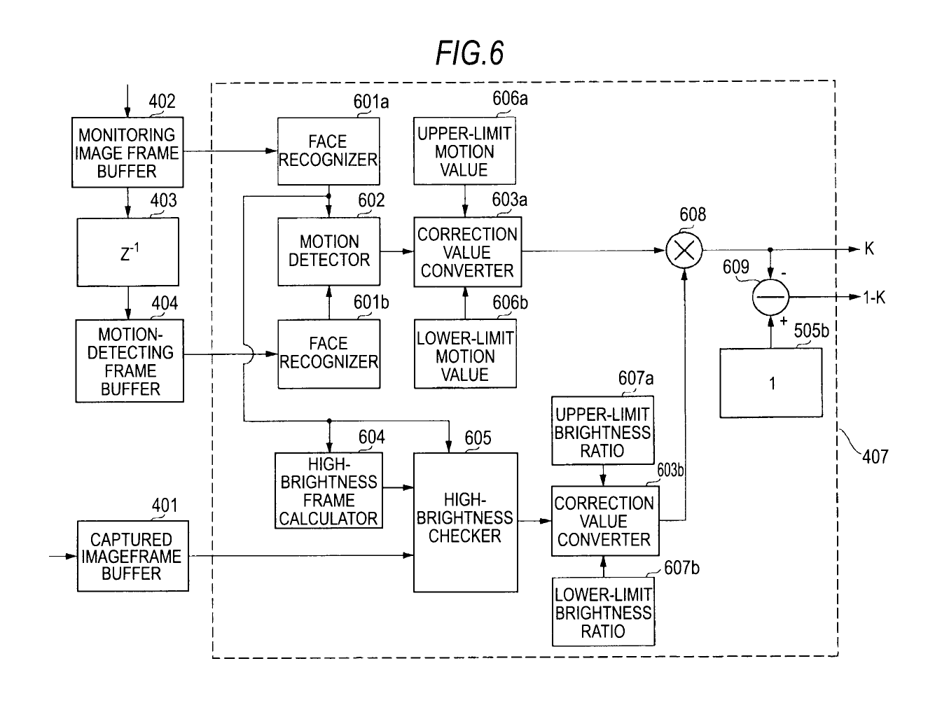

FIG. 6 is a functional block diagram illustrating the configuration of the mixing coefficient calculator 407.

The monitoring image data stored in the monitoring image frame buffer 402 is supplied to a face recognizer 601a which can also be referred to as a subject recognizer recognizing a subject. The face recognizer 601a recognizes the position and size of a person's face as a subject included in the monitoring image data, and outputs coordinate data of a rectangular shape covering the face. Thereafter, the “rectangular shape covering a face” is referred to as a face frame. The coordinated data output from the face recognizer 601a is referred to as face frame coordinate data.

The monitoring image data, which is previous by one frame to the monitoring image data of the monitoring image frame buffer 402, stored in the motion-detecting frame buffer 404 is supplied to a face recognizer 601b. The face recognizer 601b recognizes the position and size of a person's face as a subject included in the monitoring image data and outputs face frame coordinate data.

The face frame coordinate data output from the face recognizer 601a and the face frame coordinate data output from the face recognizer 601b are input to a motion detector 602. The motion detector 602 calculates center point coordinates of the face frame coordinate data, calculates a distance between the center points, and outputs the calculated distance to a correction value converter 603a. Thereafter, the distance between the center points output from the motion detector 602 is referred to as a face frame movement.

On the other hand, the face frame coordinate data of the monitoring image data output from the face recognizer 601b to the motion detector 602 is output to a high-brightness frame calculator 604 and a high-brightness checker 605.

The high-brightness frame calculator 604 outputs coordinate data of a rectangular shape being similar to the face frame and covering the face frame formed by the face frame coordinate data at a constant area ratio. The area ratio is, for example, 1.25. Thereafter, the rectangular shape having a constant area ratio with respect to the face frame and being similar to the face frame is referred to as a high-brightness frame. The coordinate data output from the high-brightness frame calculator 604 is referred to as high-brightness frame coordinate data.

The high-brightness checker 605 which can also be referred to as a brightness value condition detector reads the face frame coordinate data output from the face recognizer 601b with respect to the monitoring image data, the high-brightness frame coordinate data output from the high-brightness frame calculator 604, and the captured image data stored in the captured image frame buffer 401. Then, among the captured image data, a ratio of the average brightness of the pixels in the area surrounded with the high-brightness frame but not surrounded with the face frame and the average brightness of the pixels in the area surrounded with the face frame is calculated. Hereinafter, the ratio, which is output from the high-brightness checker 605, of the average brightness of the pixels in the area surrounded with the high-brightness frame but not surrounded with the face frame and the average brightness of the pixels in the area surrounded with the face frame is referred to as an average brightness ratio.

### [Face Frame and High-Brightness Frame]

The face frame, the face frame coordinate data, the high-brightness frame, and the high-brightness frame coordinate data will be described with reference to the drawings.

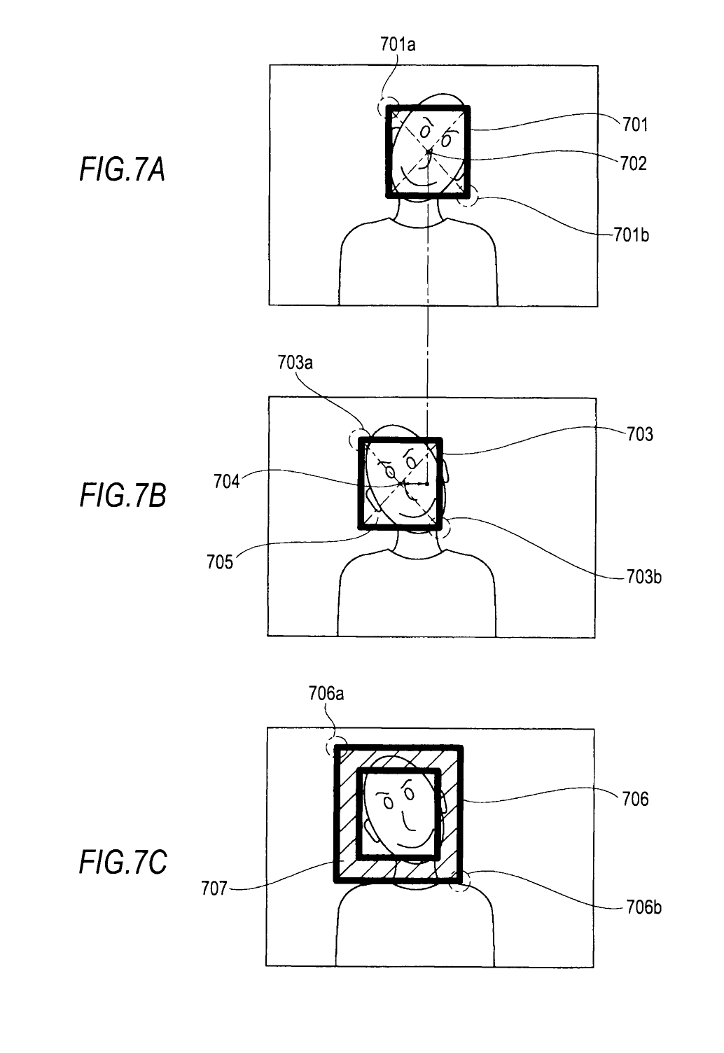

FIG. 7A is a diagram schematically illustrating the relation between the monitoring image data stored in the motion-detecting frame buffer 404 and the face frame, FIG. 7B is a diagram schematically illustrating the relation between the monitoring image data stored in the monitoring image frame buffer 402 and the face frame, and FIG. 7C is a diagram schematically illustrating the relation between the captured image data, the face frame, and the high-brightness frame.

FIG. 7A shows a state where the monitoring image data stored in the motion-detecting frame buffer 404 is developed on a screen.

The face recognizer 601b recognizes a person's face included in the monitoring image data and calculates a rectangular face frame 701 covering the face. The face frame 701 can be expressed by upper-left and lower-right coordinate data. These are the face frame coordinate data. The face frame coordinate data includes face frame coordinates 701a and 701b.

FIG. 7B shows a state where the monitoring image data stored in the monitoring image frame buffer 402 is developed on the screen, similarly to FIG. 7A.

The face recognizer 601b recognizes the person's face included in the captured image data, calculates a rectangular face frame 703 covering the face, and outputs upper-left and lower-right coordinate data of the face frame 703, that is, the face frame coordinate data.

Comparing FIGS. 7A and 7B, the person's face as a subject is moving. Accordingly, the center point of the face frame moves from the center point 702 of the face frame 701 to a center point 704 of the face frame 703. The motion detector 602 calculates the distance between the center points.

Hereinafter, the area surrounded with the face frame 703 is referred to as a face frame area 705.

FIG. 7C shows a state where the captured image data is developed on the screen, similarly to FIGS. 7A and 7B.

The high-brightness frame calculator 604 multiplies the area of the face frame 703 by a predetermined constant (1.25 in this embodiment) and calculates a rectangular shape having the same center and aspect ratio as the face frame 703, that is, similar to the face frame. This is a high-brightness frame 706.

Hereinafter, the area surrounded with the high-brightness frame 706 but not surrounded with the face frame 703 is referred to as a “high-brightness check area 707”.

The high-brightness check area 707 is an area used to detect the confusion potential with an area of a subject illuminated by the flash by applying light from the rear side of the person's face as the subject. That is, the high-brightness check area is an area to be subjected to a brightness check for detecting whether light is applied from the rear side of the face.

### [High-Brightness Checker]

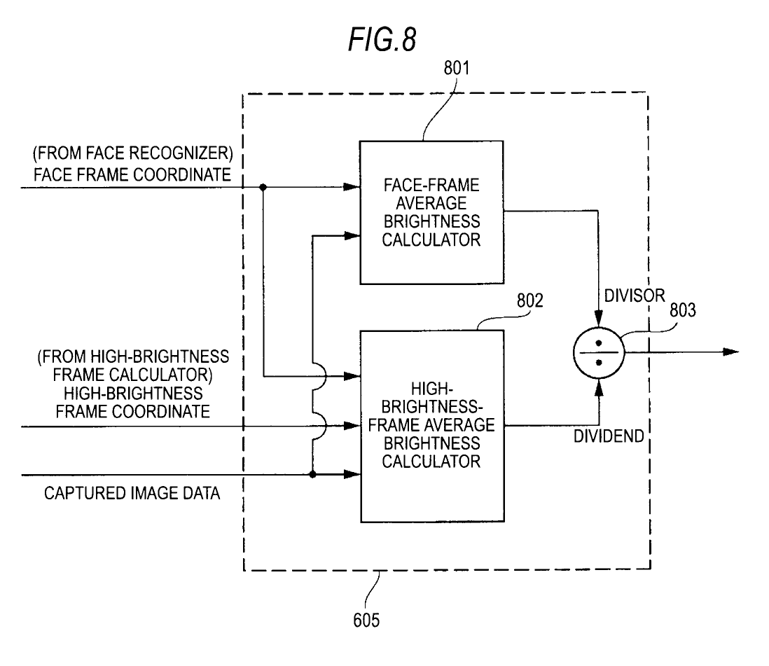

FIG. 8 is a functional block diagram illustrating the configuration of the high-brightness checker 605.

A face-frame average brightness calculator 801 calculates the average brightness (the face-frame-area average brightness) of the pixels in the face frame area 705 from the captured image data on the basis of the face frame coordinate data.

A high-brightness-frame average brightness calculator 802 calculates the average brightness (the high-brightness-check-area average brightness) of the pixels in the high-brightness check area 707 from the captured image data on the basis of the face frame coordinate data and the high-brightness frame coordinate data.

A divider 803 outputs a value obtained by dividing the high-brightness-check-area average brightness by the face-frame-area average brightness, that is, the average brightness ratio.

The mixing coefficient calculator 407 will continue to be described with reference to FIG. 6.

The face frame movement output from the motion detector 602 is input to the correction value converter 603a.

The correction value converter 603a converts the face frame movement into a numerical value in the range of 0 to 1 with reference to an upper-limit motion value 606a and a lower-limit motion value 606b.

The average brightness ratio output from the high-brightness checker 605 is input to a correction value converter 603b.

The correction value converter 603b converts the average brightness ratio into a numerical value in the range of 0 to 1 with reference to an upper-limit brightness ratio 607a and a lower-limit brightness ratio 607b.

### [Correction Value Converter]

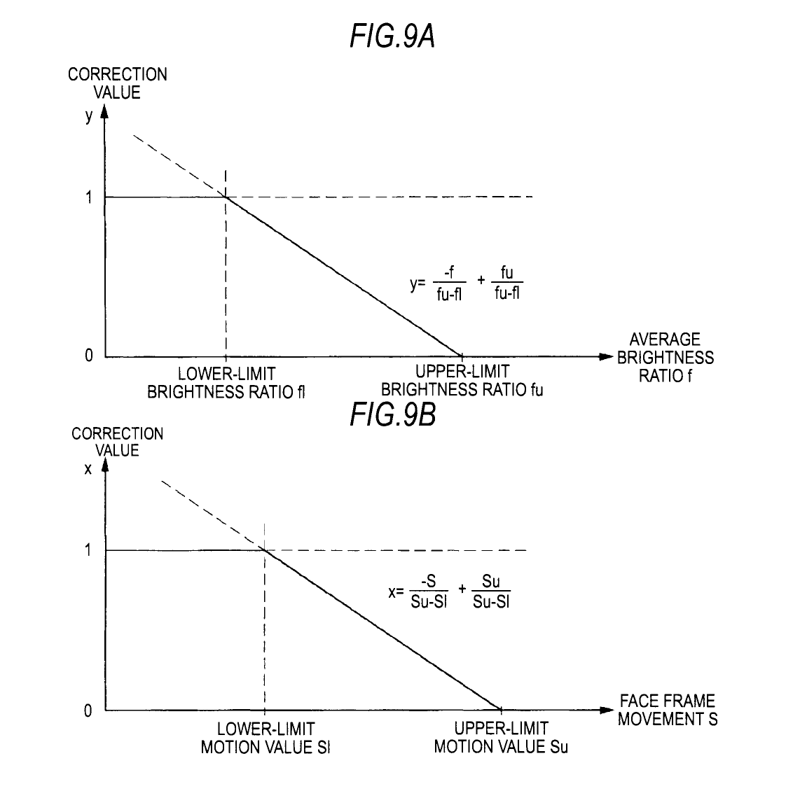

FIGS. 9A and 9B are graphs illustrating the input and output relation of the correction value converter 603a and the correction value converter 603b.

FIG. 9A is a graph of the correction value converter 603a receiving the face frame movement as an input and outputting a correction value x.

The correction value converter 603a can be expressed by the following function.

x=0 (s≧su)

x=1 (s≦sl)

x=(−s+su)/(su−sl) (1<s<sl)

That is, the correction value x is 0 when the face frame movement s is equal to or greater than an upper-limit motion value su, the correction value x is 1 when the face frame movement s is equal to or less than a lower-limit motion value sl, and the correction value x is a linear function with a slope of −1/(su−sl) and a y-intercept of su/(su−sl) when the face frame movement s is greater than the lower-limit motion value sl and less than the upper-limit motion value su.

FIG. 9B is a graph of the correction value converter 603b receiving the average brightness ratio as an input and outputting a correction value y.

The correction value converter 603b can be expressed by the following function.

y=0 (f≧fu)

y=1 (f≦fl)

y=(−f+fu)/(fu−fl) (1<f<fl)

That is, the correction value y is 0 when the average brightness ratio f is equal to or greater than an upper-limit brightness ratio fu, the correction value y is 1 when the average brightness ratio f is equal to or less than a lower-limit brightness ratio fl, and the correction value y is a linear function with a slope of −1/(fu−fl) and a y-intercept of fu/(fu−fl) when the average brightness ratio f is greater than the lower-limit brightness ratio fl and less than the upper-limit brightness ratio fu.

The correction value x based on the face frame movement and rounded to a numerical value in the range of 0 to 1 by the correction value converter 603a and the correction value y based on the average brightness ratio and rounded to a numerical value in the range of 0 to 1 by the correction value converter 603b are multiplied by a multiplier 608. The output of the multiplier 608 is output as a mixing coefficient k to the mixing coefficient “k” memory 410. The output of the multiplier 608 is subtracted from the numerical value “1” 505b by a subtracter 609 and is output as a mixing coefficient 1−k to the mixing coefficient “1−k” memory 412.

The correction value converter 603a, the upper-limit motion value 606a, the lower-limit motion value 606b, the correction value converter 603b, the upper-limit brightness ratio 607a, the lower-limit brightness ratio 607b, and the multiplier 608 can also be referred to as a mixing coefficient deriving section that derives the mixing coefficient k on the basis of the face frame movement and the average brightness ratio.

### [Operation]

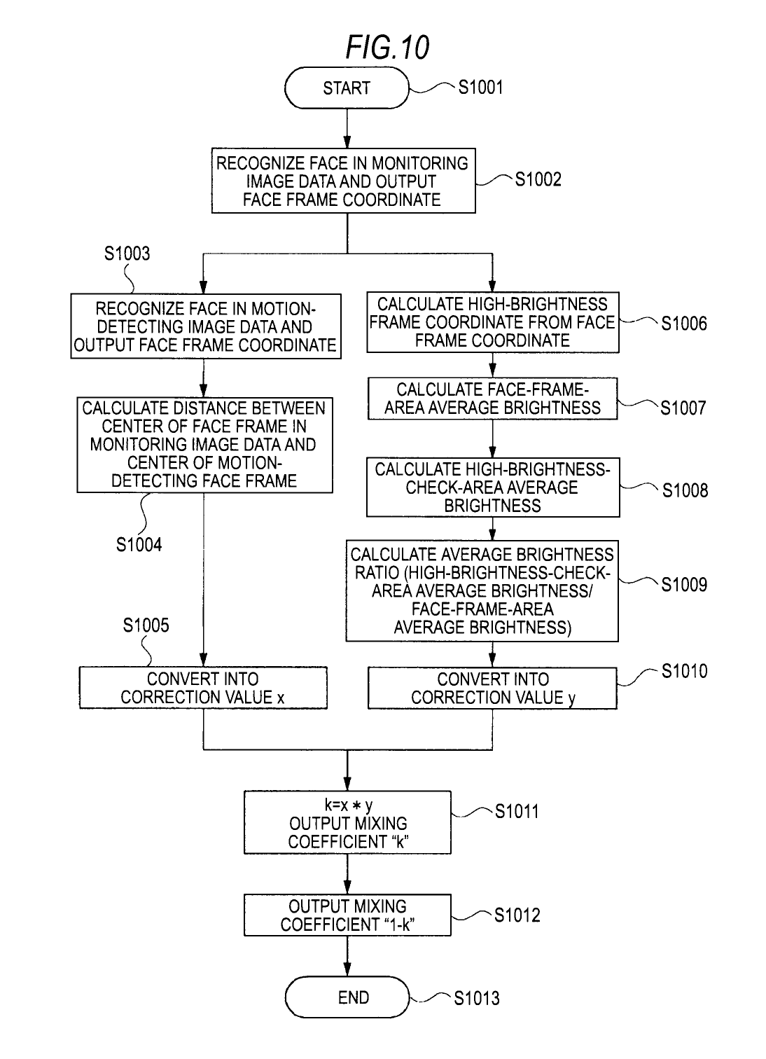

FIG. 10 is a flow diagram illustrating a flow of processes of calculating the mixing coefficients “k” and “1−k”, which is performed by the mixing coefficient calculator 407.

When the flow of processes is started (S1001), the face recognizer 601a first performs a face recognizing process on the basis of the monitoring image data stored in the monitoring image frame buffer 402 and outputs the face frame coordinate data (S1002).

The face frame coordinate data output in step S1002 is supplied to a process (steps S1003, S1004, and S1005) of calculating the face frame movement and acquiring the correction value x and a process (steps S1006, S1007, S1008, S1009, and S1010) of calculating the average brightness ratio and acquiring the correction value y. Hereinafter, it is assumed that the mixing coefficient calculator 407 is a multi-thread or multi-process program and the process of calculating the face frame movement and acquiring the correction value x and the process of calculating the average brightness ratio and acquiring the correction value y are simultaneously performed in parallel.

The face recognizer 601b performs a face recognizing process on the basis of the monitoring image data stored in the motion-detecting frame buffer 404 and outputs the face frame coordinate data (S1003).

The motion detector 602 calculates the center points from the face frame coordinate data output in step S1002 and the face frame coordinate data output in step S1003 and calculates the distance between the center points, that is, the face frame movement (S1004).

The face frame movement calculated by the motion detector 602 is converted into the correction value x by the correction value converter 603a (S1005).

On the other hand, the high-brightness frame calculator 604 calculates the high-brightness frame coordinate data on the basis of the face frame coordinate data output from the face recognizer 601a (S1006).

The face-frame average brightness calculator 801 of the high-brightness checker 605 reads the face frame coordinate data output from the face recognizer 601a and the captured image data in the captured image frame buffer and calculates the average brightness (the face-frame-area average brightness) of the pixels in the face frame area 705 (S1007).

The high-brightness-frame average brightness calculator 802 of the high-brightness checker 605 reads the face frame coordinate data output from the face recognizer 601a, the high-brightness frame coordinate data output from the high-brightness frame calculator 604, and the captured image data in the captured image frame buffer and calculates the average brightness (the high-brightness-check-area average brightness) of the pixels in the high-brightness check area 707 (S1007).

The divider 803 outputs a value obtained by dividing the high-brightness-check-area average brightness by the face-frame-area average brightness, that is, the average brightness ratio (S1009).

The average brightness ratio calculated by the high-brightness checker 605 is converted into the correction value y by the correction value converter 603b (S1010).

The correction value x calculated by the correction value converter 603a in step S1005 and the correction value y calculated by the correction value converter 603a in step S1010 are multiplied by the multiplier 608 to output the mixing coefficient “k” (S1011). The mixing coefficient “k” is subtracted from the numerical value “1” 505b by the subtracter 609 to output the mixing coefficient “1−k” (S1012) and the flow of processes is ended (S1013).

As described above, the mixing coefficient calculator 407 performing the flow of processes shown in FIG. 10 creates the mixing coefficient “k” in which the motion of a subject and the brightness of the background of the subject are reflected. The mixing coefficient “k” varies depending on the state of the subject. Accordingly, when the subject is moving, or when the background of the subject is bright, or when both conditions are satisfied, the corrected white balance map becomes close to the white balance value not causing the color shift to be difficult.

The following applications can be considered in this embodiment.

(1) The face recognizers 601a and 601b may be changed depending on the type of subject.

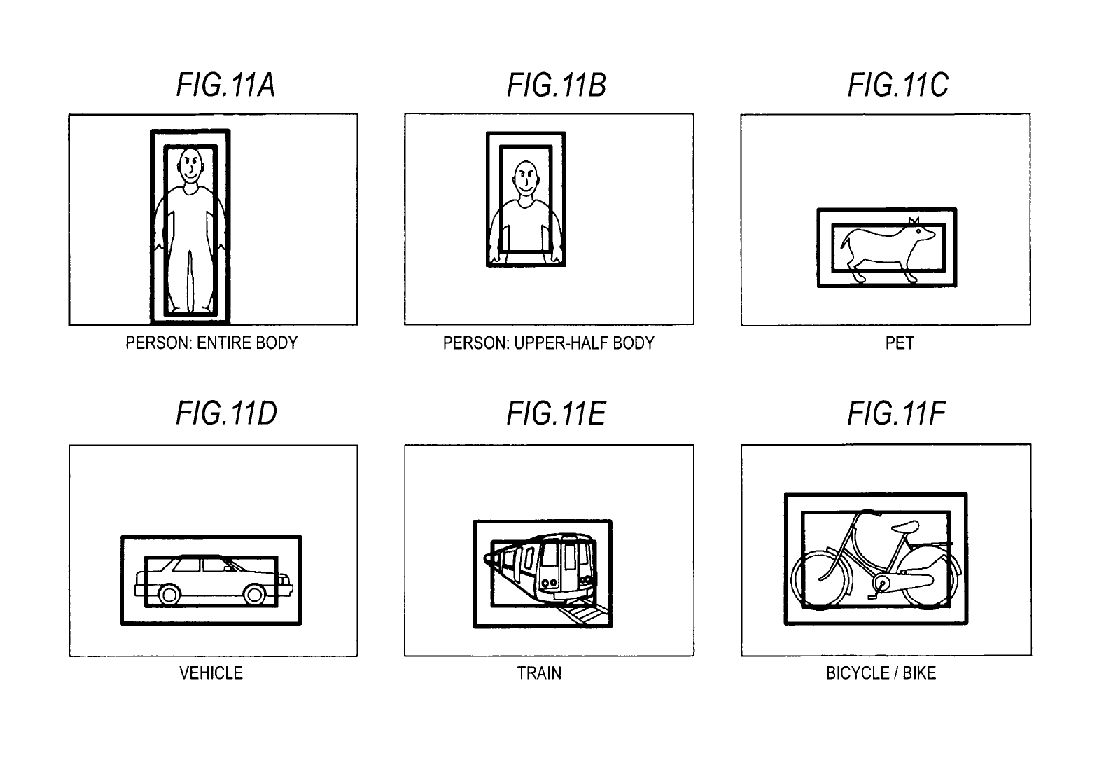

FIGS. 11A, 11B, 11C, 11D, 11E, and 11F are diagrams schematically illustrating the relation between a subject, a subject identification frame, and a high-brightness frame.

A subject is identified depending on an imaging mode of which plural types of set values are stored in the ROM 203 in advance, and the subject identification frame appropriately corresponding to the subject is defined.

The face recognizers 601a and 601b appropriately change an algorithm for identifying a subject depending on the imaging mode and sets a subject identification frame. In this case, the face recognizers 601a and 601b serve as a subject recognizer recognizing a designated subject.

(2) The correction value converters 603a and 603b in the above-mentioned embodiment perform a linear-function conversion process on an input value.

To implement the optimal conversion process, the upper-limit motion value 606a, the lower-limit motion value 606b, the upper-value brightness ratio 607a, the lower-limit brightness ratio 607b, and the curve of the conversion function may be set using a learning algorithm. The optimal correction coefficient “k” is designated for the image data previously obtained by imaging a sample subject under various illumination conditions. Plural sets of the imaging condition and the correction coefficient “k” obtained in this way are prepared and the correction value converters 603a and 603b are constructed using the learning algorithm.

(3) The correction value converters 603a and 603b in the above-mentioned embodiment perform the linear-function conversion process on an input value.

To implement a simpler conversion process, a discrete conversion process may be performed using a table.

(4) The subject identification frame including the face frame may not be necessarily rectangular. When a face is a subject, an elliptical shape is ideal. A frame, which can accurately identify the shape of a subject and in which a wasteful space is as small as possible between the subject and the identification frame, can be referred to as an excellent identification frame. When this non-rectangular identification frame is used, the center of gravity is preferably calculated instead of the center point of the identification frame.

(5) The high-brightness frame may not necessarily have a shape similar to the subject identification frame. The frame may be a frame configured to surround the subject identification frame with a constant gap from the subject identification frame.

(6) The processing details of the high-brightness checker 605 shown in FIG. 8 may employ a method of comparing the brightness of the pixels in the high-brightness check area with a predetermined threshold and outputting the area ratio of the pixels brighter than the threshold to the high-brightness check area as a simpler method.

(7) The techniques embodied by the digital camera 101 according to the above-mentioned embodiment are improvements of the white balance process. Referring to FIGS. 3 to 10, the technique is the improvement of the image process after the imaging other than the process of the imaging processor. Referring to FIG. 2, this is the improvement of a control program of a micro computer and a calculation program of a DSP, that is, the software improvement.

Therefore, a system utilizing the characteristics of a flash memory having a tendency to increase in capacity may be constructed in which the digital camera does not perform the image processing part of the white balance process but performs only the imaging while the image processing part is provided to an external information processing device such as a PC.

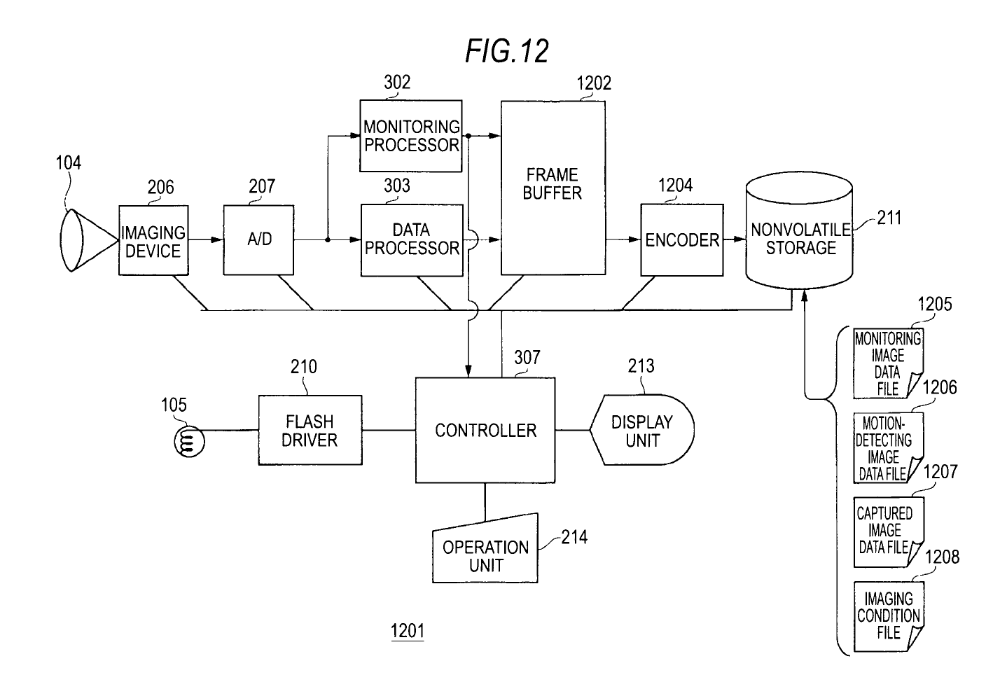

FIG. 12 is a functional block diagram illustrating the configuration of such a digital camera. In this example, a frame buffer 1202 is provided instead of the white balance processor 301 in the digital camera 101 shown in FIG. 3.

The digital camera 1201 shown in FIG. 12 perform only the generating of the captured image data at the time of pushing the shutter button 106, the generating of the monitoring image data immediately previous to the time of pushing the shutter button 106, and the generating of the monitoring image data previous to the time of pushing the shutter button 106 by one more frame, and an encoder 1204 performs an encoding process using a reversible compression algorithm so as to prevent the deterioration of the image. That is, in the formats such as JPEG EX, PNG, and TIFF employing a reversible compression algorithm instead of JPEG employing a known irreversible compression algorithm, three image data files of a captured image data file 1207 obtained by reversibly encoding the captured image data at the time of pushing the shutter button 106, a monitoring image data file 1205 obtained by reversibly encoding the monitoring image data immediately previous to the time of pushing the shutter button 106, and a motion-detecting image data file 1206 obtained by reversibly encoding the monitoring image data previous to the time of pushing the shutter 106 by one more frame and an imaging information file 1208 are recorded in the nonvolatile storage 211.

It is necessary to separately store at least the information of the focal distance as the imaging information. Therefore, the imaging information is described in the imaging information file 1208 which is recorded in the nonvolatile storage 211.

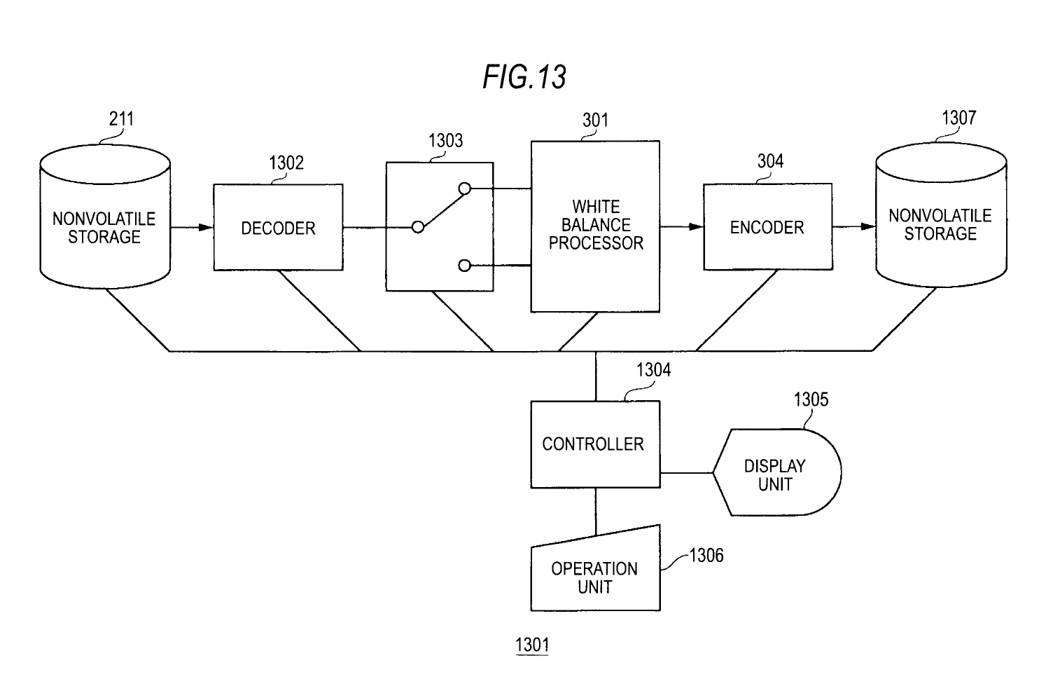

FIG. 13 is a functional block diagram illustrating the configuration of an image processing device. By reading programs associated with the white balance process to a PC and executing the read programs, the PC performs the function of the image processing device 1301.

By connecting the nonvolatile storage 211 such as a flash memory taken out of the digital camera 1201 to the PC via an interface not shown or connecting the digital camera 1201 to the PC via a USB interface 212, the nonvolatile storage 211 is connected to a decoder 1302 in the PC.

The decoder 1302 reads three image data files of the captured image data file 1207, the monitoring image data file 1205, and the motion-detecting image data file 1206, which are stored in the nonvolatile storage 211, converts the read image data files into the original image data, and supplies the original image data to the white balance processor 301 via a selection switch 1303. Since the imaging information file 1208 is also stored in the nonvolatile storage 211, the controller 1003 reads the imaging information file 1208 and utilizes the imaging information file as the reference information for controlling the white balance processor 301.

The operation after the process of the white balance processor 301 is equal to that of the digital camera 101 shown in FIG. 3.

When the digital camera 1201 and the image processing device 1301 are constructed in this way, a user of a past digital camera can advantageously substantially enjoy the function of the white balance process described in this embodiment only by updating a firmware mounting the process of generating three image data files of the captured image data file 1207, the monitoring image data file 1205, and the motion-detecting image data file 1206 and the process of generating the imaging information file 1208 on the past digital camera of which the calculation capability is not enough.

The image processing device 1301 shown in FIG. 13 is a device performing a post-processing using three image data files of the captured image data file 1207, the monitoring image data file 1205, and the motion-detecting image data file 1206 and the imaging information file 1208. Accordingly, it is possible to change the behavior of the face recognizers 601a and 601b and the like by changing an imaging scene to be set and to repeatedly perform the white balance process. In general, the PC generally has greater calculation capability than the digital camera 1201. Accordingly, when the part of the post-processing is designed to be separated from the digital camera 1201 and to be provided to the PC, the digital camera 1201 has only to have a large-capacity nonvolatile storage 211 and an encoder 1204 employing a reversible compression algorithm. That is, since the digital camera 1201 may not necessarily have great calculation capability, it is possible to further contribute to a decrease in size and a decrease in power consumption of the digital camera 1201.

(8) For example, an example where a very small person appears in a large landscape is considered. In this case, even when a face frame and a high-brightness frame can be applied, the color shift occurring in this image is recognized as a negligible phenomenon (not attracting attention) by a viewer. That is, when the area of a face (primary subject) is small and the calculation of the white balance fails, an impression on the viewer is small and thus the neglect of the influence of the face movement or the high brightness does not cause any problem.

Therefore, by calculating the ratio of the area of the face frame to the total area of an image, utilizing the mixing coefficient k without any change when the area ratio is great (the face area is great), bringing the value of the mixing coefficient k close to 1 when the face area is small, and utilizing the correcting expression using the white balance in the unit of pixels calculated from a non-luminous image and a luminous image, it is possible to implement the optical correction calculation depending on the face area.

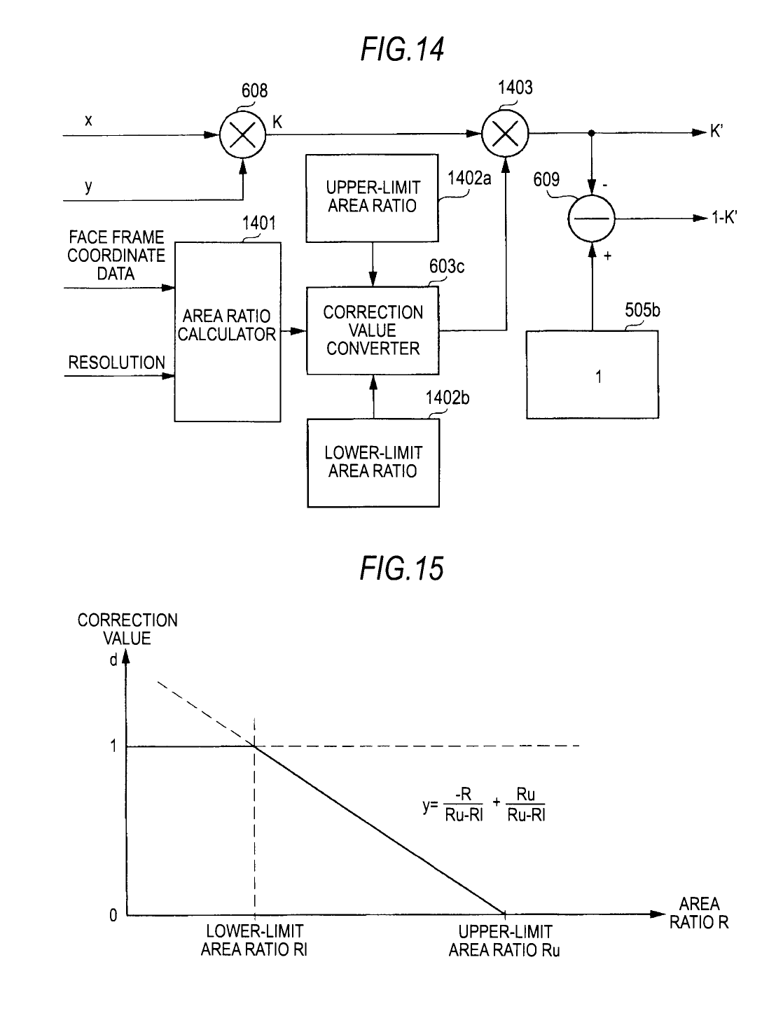

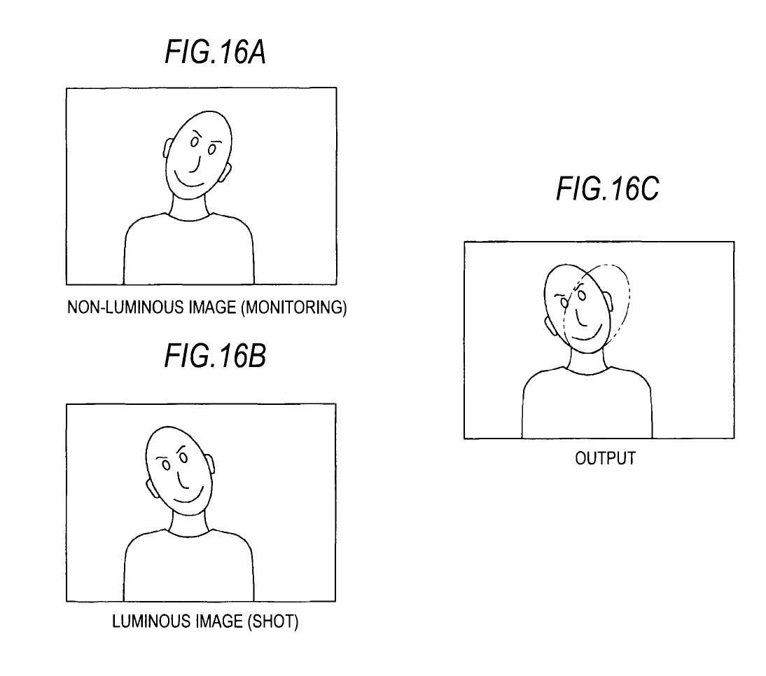

FIG. 14 is a functional block diagram illustrating the mixing coefficient calculator 407 of which a part is modified.

An area ratio calculator 1401 receives the face frame coordinate data output from the face recognizer 601a and the information of a resolution acquired from the controller 307 as an input and outputs a ratio of the area of a face frame to the total area of the image data.

The area ratio output from the area ratio calculator 1401 is input to a correction value converter 603c.

The correction value converter 603c converts the area ratio into a numerical value in the range of 0 to 1 with reference to an upper-limit area ratio 1402a and a lower-limit area ratio 1402b.

The mixing coefficient k which is the output of the multiplier 608 shown in FIG. 6 is input to a multiplier 1403.

The multiplier 1403 receives a correction value α output from the correction value converter 603c as an input and outputs a mixing coefficient k′ instead of the mixing coefficient k to the mixing coefficient “k” memory 410. The output of the multiplier 1403 is subtracted from the numerical value “1” 505b by the subtracter 609 and is output as a mixing coefficient 1−k′ instead of the mixing coefficient 1−k to the mixing coefficient “1−k” memory 412.

FIG. 15 is a graph illustrating the input and output relation of the correction value converter 603c.

The correction value converter 603c can be expressed by the following function.

α=0 (R≧Ru)

α=1 (R≦Rl)

α=(−R+Ru)/(Ru−Rl) (1<R<Rl)

That is, the correction value α is 0 when the area ratio R is equal to or greater than an upper-limit area ratio Ru, the correction value α is 1 when the area ratio R is equal to or less than a lower-limit area ratio Rl, and the correction value α is a linear function with a slope of −1/(Ru−Rl) and a y-intercept of Ru/(Ru−Rl) when the area ratio R is greater than the lower-limit area ratio Rl and less than the upper-limit area ratio Ru.

In this way, the correction value α based on the area ratio and rounded to a numerical value in the range of 0 to 1 by the correction value converter 603c is multiplied by the mixing coefficient k by the multiplier 1403.

A digital camera and an image processing device have been disclosed in this embodiment.

According to the embodiment, the mixing coefficient calculator is disposed which changes a mixture ratio on the basis of the motion of the subject and the brightness of the background of the subject at the time of creating the corrected white balance map by mixing the white balance value used to set uniform white balance all over the captured image data with the white balance map used to set the optimal white balance based on the brightness of the pixels of the captured image data. Accordingly, by changing the mixing coefficient, it is possible to prevent the color shift and to perform an appropriate white balance correcting process on the basis of the motion of a subject and the brightness of the background of the subject.

While the embodiment of the present disclosure has been described, the present disclosure is not limited to the embodiment, but may include other modifications and applications without departing from the concept of the present disclosure described in the appended claims.

The present disclosure contains subject matter related to that disclosed in Japanese Priority Patent Application JP 2010-154262 filed in the Japan Patent Office on Jul. 6, 2010, the entire contents of which is hereby incorporated by reference.

What is claimed is:

1. An image processing device comprising:
an image generating unit that generates third image data on the basis of first image data and second image data different in exposure condition from the first image data;
a subject recognizer that recognizes a predetermined subject on the basis of the first image data; and
a brightness value condition detector that detects a brightness value condition of an area around the predetermined subject recognized by the subject recognizer in the first image data,
wherein the image generating unit generates the third image data on the basis of the detection result in the brightness value condition detector.

2. An image processing device according to claim 1, further comprising:
a mixing coefficient calculator that calculates a mixing coefficient depending on a ratio of an area of which the brightness value is greater than a predetermined value in the area around the subject, and
the image generating unit calculates a white balance map varying for every area of the image data on the basis of the first image data and the second image data and generates the third image data depending on the mixing coefficient on the basis of the white balance map and the first image data or the second image data.

3. The image processing device according to claim 2, further comprising:
a motion detector that detects a movement of the subject; and
a high-brightness checker that calculates a ratio of the brightness of the subject and the brightness around the subject and outputs an average brightness ratio,
wherein the mixing coefficient calculator calculates the mixing coefficient on the basis of the movement and the average brightness ratio.

4. The image processing device according to claim 3,
wherein the subject recognizer outputs information of a subject identification frame surrounding the recognized subject, and
the motion detector detects the movement just before imaging the subject on the basis of the information of the subject identification frame.

5. The image processing device according to claim 4, further comprising:
a high-brightness frame calculator that outputs information of a high-brightness frame surrounding the subject identification frame from the information of the subject identification frame,
wherein the high-brightness checker calculates a face-frame-area average brightness which is an average brightness of pixels belonging to a face frame area surrounded with the subject identification frame among the captured image data and a high-brightness-check-area average brightness which is an average brightness of pixels belonging to a high-brightness check area surrounded with the subject identification frame and the high-brightness frame among the captured image data on the basis of the information of the subject identification frame and the information of the high-brightness frame, and outputs an average brightness ratio obtained by dividing the high-brightness-check-area average brightness by the face-frame-area average brightness.

6. An image processing method comprising:
recognizing a predetermined subject on the basis of first image data;
detecting a brightness value condition of an area around the recognized predetermined subject in the first image data; and
generating third image data on the basis of the first image data and second image data different in exposure condition from the first image data.

7. An image processing program allowing an information processing device to execute the processing comprising:
recognizing a predetermined subject on the basis of first image data;
detecting a brightness value condition of an area around the recognized predetermined subject in the first image data; and
generating third image data on the basis of the first image data and second image data different in exposure condition from the first image data.
